(19) United States
(12) Patent Application Publication
(10) Pub. No.: US 2025/0040536 A1
(43) Pub. Date: Feb. 6, 2025

(54) HUNTING BLIND

(71) Applicant: Jesse Croft, Douglas, GA (US)

(72) Inventor: Jesse Croft, Douglas, GA (US)

(21) Appl. No.: 18/229,430

(22) Filed: Aug. 2, 2023

(51) Int. Cl. A01M 31/02

(52) U.S. Cl. CPC A01M 31/025; A01M 31/02

(57) ABSTRACT

A hunting blind apparatus for obscuring an occupant of a hunting stand includes a panel having a front surface and a rear surface. The panel also has a top edge, a bottom edge, a first lateral edge, and a second lateral edge. A camouflage is mounted to the front surface of the panel which is configured to visually simulate foliage, and a mount is coupled to the panel adjacent to the top edge of the panel which is configured to engage a railing of the hunting stand such that the panel hangs downwardly from the railing.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to hunting blinds and more particularly pertains to a new hunting blind for obscuring an occupant of a hunting stand.

### (2) Description of Related Art Including Information Disclosed Under 37 CFR 1.97 and 1.98

The prior art discloses myriad hunting blinds, including hunting blinds which use artificial tree branches to obscure an individual. However, the prior art fails to describe a hunting blind that comprises a panel with a plurality of artificial tree branches attached to a front surface of the panel, wherein the panel is adapted to attach to a hunting stand to obscure an occupant of the hunting stand. Such an apparatus is desirable over the prior art because a panel may obscure a wider area than a similar device using only artificial tree branches, while the inclusion of artificial tree branches facilitates camouflaging the panel to reflect a natural environment.

### BRIEF SUMMARY OF THE INVENTION

An embodiment of the disclosure meets the needs presented above by generally comprising a panel having a front surface and a rear surface. The panel also has a top edge, a bottom edge, a first lateral edge, and a second lateral edge. A camouflage is mounted to the front surface of the panel which is configured to visually simulate foliage, and a mount is coupled to the panel adjacent to the top edge of the panel which is configured to engage a railing of a hunting stand such that the panel hangs downwardly from the railing.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a hunting blind apparatus according to an embodiment of the disclosure.

FIG. 2 is a front view of an embodiment of the disclosure.

FIG. 3 is a rear view of an embodiment of the disclosure.

FIG. 4 is a side view of an embodiment of the disclosure.

FIG. 5 is an in-use view of an embodiment of the disclosure.

### DETAILED DESCRIPTION OF THE INVENTION

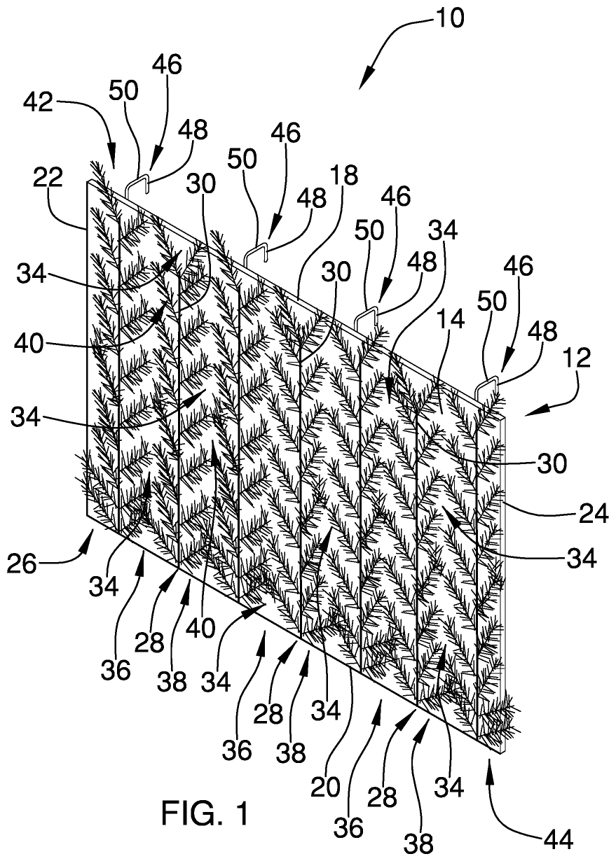

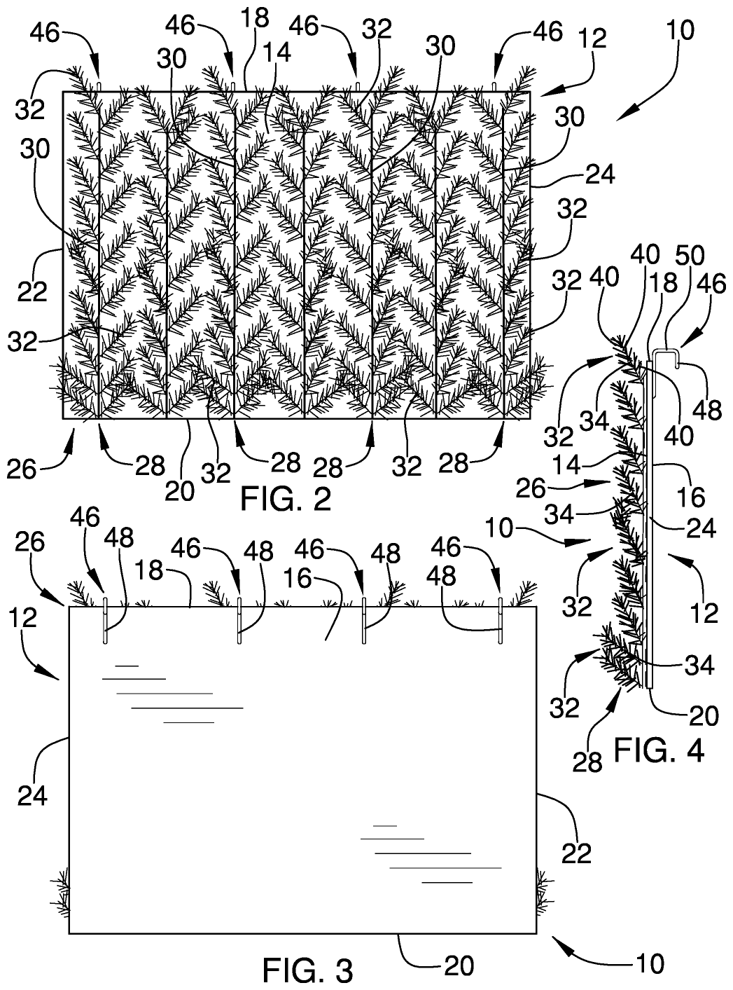

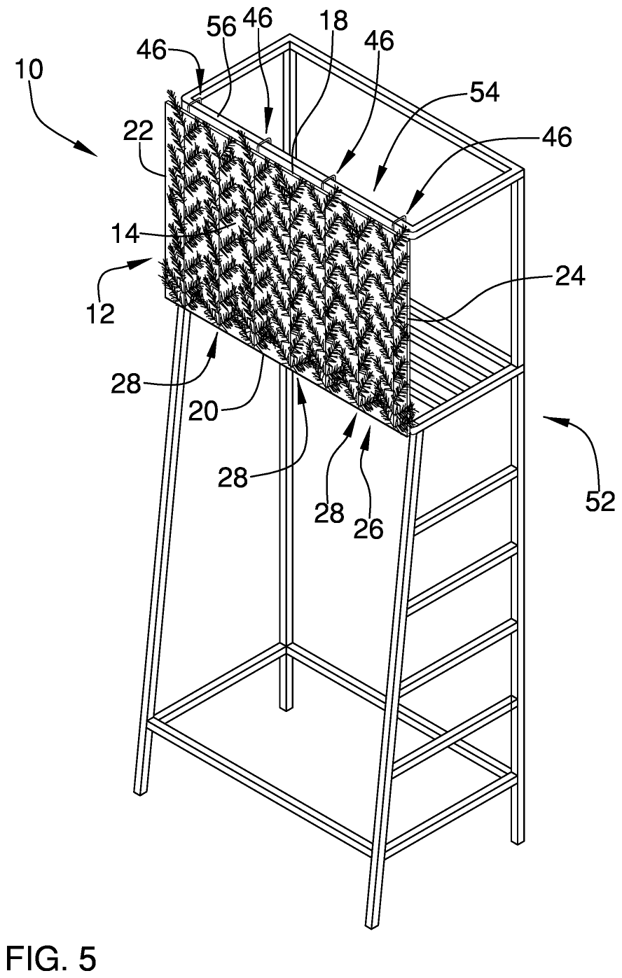

With reference now to the drawings, and in particular to FIGS. 1 through 5 thereof, a new hunting blind embodying the principles and concepts of an embodiment of the disclosure and generally designated by the reference numeral 10 will be described.

As best illustrated in FIGS. 1 through 5, the hunting blind apparatus 10 generally comprises a panel 12 having a front surface 14 and a rear surface 16. The panel 12 also has a top edge 18, a bottom edge 20, a first lateral edge 22, and a second lateral edge 24, and a shape of the panel 12 is rectangular. A camouflage 26 is mounted to the front surface 14 of the panel 12 which is configured to visually simulate foliage. The camouflage 26 comprises a plurality of artificial tree branches 28 which are laterally spaced from each other across the front surface 14 of the panel 12. Each artificial tree branch 28 of the plurality of artificial tree branches 28 is shaped such that each artificial tree branch 28 is configured to simulate an evergreen tree branch.

Each artificial tree branch 28 of the plurality of artificial tree branches 28 comprises an elongated member 30 and a plurality of twig members 32. The elongated member 30 extends upwardly from the bottom edge 20 of the panel 12, and the plurality of twig members 32 is coupled to the elongated member 30. Each twig member 32 of the plurality of twig member 32 has a central member 34 that is coupled to and extends outwardly from the elongated member 30. The central members 34 of a first set 36 of twig members 32 of the plurality of twig members 32 extend toward the first lateral edge 22 of the panel 12 from the elongated member 30, and the central members 34 of a second set 38 of twig members 32 of the plurality of twig members 32 extend toward the second lateral edge 24 of the panel 12 from the elongated member 30. The central member 34 of each twig member 32 of the plurality of twig members 32 is angled upwardly from the elongated member 30.

Each twig member 32 of the plurality of twig members 32 has a plurality of filaments 40 coupled to and extending outwardly from the central member 34 thereof. The plurality of twig members 32 is dispersed in an irregular pattern along the elongated member 30. An uppermost one to two twig members 32 of the plurality of twig members 32 extend upwardly past the top edge 18 of the panel 12.

The plurality of artificial tree branches 28 includes a first outermost artificial tree branch 42 which is positioned adjacent to the first lateral edge 22 of the panel 12 and a second outermost artificial tree branch 44 which is positioned adjacent to the second lateral edge 24 of the panel 12. At least some of the plurality of twig members 32 of the first outermost artificial tree branch 42 extend past the first lateral edge 22, and at least some of the plurality of twig members 32 of the second outermost artificial tree branch 44 extend past the second lateral edge 24.

A mount 46 is coupled to the panel 12 adjacent to the top edge 18 of the panel 12 and is configured to engage a railing 54 of a hunting stand 52 wherein the panel 12 hangs downwardly from the railing 54. The mount 46 comprises a J-hook 48 and has a straight section 50 which is positioned such that the straight section 50 is configured to rest flush against a horizontal upper surface 56 of the railing 54 of the hunting stand 52.

In use, the hunting blind apparatus 10 is mounted to the railing 54 of the hunting stand 52 to inconspicuously obscure an occupant of the hunting stand 52.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A hunting blind apparatus comprising:
an elevated hunting stand having an uppermost railing;
a panel having a front surface and a rear surface, the panel having a top edge, a bottom edge, a first lateral edge, and a second lateral edge;
a camouflage being mounted to the front surface of the panel, the camouflage being configured to visually simulate foliage; and
a mount being coupled to the panel adjacent to the top edge of the panel, the mount extending upwardly relative to the top edge of the panel and engaging the uppermost railing of the hunting stand wherein the panel hangs downwardly from the uppermost railing.

2. The apparatus of claim 1, wherein a shape of the panel is rectangular.

3. The apparatus of claim 1, wherein the camouflage comprises a plurality of artificial tree branches.

4. The apparatus of claim 3, wherein the plurality of artificial tree branches is laterally spaced from each other across the front surface of the panel.

5. The apparatus of claim 3, wherein each artificial tree branch of the plurality of artificial tree branches is shaped such that each artificial tree branch is configured to simulate an evergreen tree branch.

6. The apparatus of claim 3, wherein each artificial tree branch of the plurality of artificial tree branches comprises:
an elongated member extending upwardly from the bottom edge of the panel; and
a plurality of twig members being coupled to the elongated member, each twig member of the plurality of twig member having a central member being coupled to and extending outwardly from the elongated member, each twig member of the plurality of twig members having a plurality of filaments being coupled to and extending outwardly from the central member thereof.

7. The apparatus of claim 6, wherein the central members of a first set of twig members of the plurality of twig members extend toward the first lateral edge of the panel from the elongated member, the central members of a second set of twig members of the plurality of twig members extending toward the second lateral edge of the panel from the elongated member, the central member of each twig member of the plurality of twig members being angled upwardly from the elongated member.

8. The apparatus of claim 6, wherein the plurality of twig members is dispersed in an irregular pattern along the elongated member.

9. The apparatus of claim 6, wherein an uppermost one to two twig members of the plurality of twig members extending upwardly past the top edge of the panel.

10. The apparatus of claim 6, wherein the plurality of artificial tree branches includes a first outermost artificial tree branch being positioned adjacent to the first lateral edge of the panel and a second outermost artificial tree branch being positioned adjacent to the second lateral edge of the panel, at least some of the plurality of twig members of the first outermost artificial tree branch extending past the first lateral edge, at least some of the plurality of twig members of the second outermost artificial tree branch extending past the second lateral edge.

11. The apparatus of claim 1, wherein the mount comprises a J-hook.

12. The apparatus of claim 11, wherein the J-hook has a straight section being positioned such that the straight section is configured to rest flush against a horizontal upper surface of the railing of the hunting stand.

13. A hunting blind apparatus comprising:
an elevated hunting stand having an uppermost railing;
a panel having a front surface and a rear surface, the panel having a top edge, a bottom edge, a first lateral edge, and a second lateral edge, a shape of the panel being rectangular;
a camouflage being mounted to the front surface of the panel, the camouflage being configured to visually simulate foliage, the camouflage comprising a plurality of artificial tree branches, the plurality of artificial tree branches being laterally spaced from each other across the front surface of the panel, each artificial tree branch of the plurality of artificial tree branches being shaped such that each artificial tree branch is configured to simulate an evergreen tree branch, each artificial tree branch of the plurality of artificial tree branches comprising:
an elongated member extending upwardly from the bottom edge of the panel; and
a plurality of twig members being coupled to the elongated member, each twig member of the plurality of twig member having a central member being coupled to and extending outwardly from the elongated member, the central members of a first set of twig members of the plurality of twig members extending toward the first lateral edge of the panel from the elongated member, the central members of a second set of twig members of the plurality of twig members extending toward the second lateral edge of the panel from the elongated member, the central member of each twig member of the plurality of twig members being angled upwardly from the elongated member, each twig member of the plurality of twig members having a plurality of filaments being coupled to and extending outwardly from the central member thereof, the plurality of twig members being dispersed in an irregular pattern along the elongated member, an uppermost one to two twig members of the plurality of twig members extending upwardly past the top edge of the panel;
the plurality of artificial tree branches including a first outermost artificial tree branch being positioned adjacent to the first lateral edge of the panel and a second outermost artificial tree branch being positioned adjacent to the second lateral edge of the panel, at least some of the plurality of twig members of the first outermost artificial tree branch extending past the first lateral edge, at least some of the plurality of twig members of the second outermost artificial tree branch extending past the second lateral edge; and
a mount being coupled to the panel adjacent to the top edge of the panel, the mount extending upwardly relative to the top edge of the panel and engaging the uppermost railing of the hunting stand wherein the panel hangs downwardly from the uppermost railing, the mount comprising a J-hook, the J-hook having a straight section being positioned such that the straight section is configured to rest flush against a horizontal upper surface of the railing of the hunting stand.
